(19) United States
(12) Patent Application Publication
(10) Pub. No.: US 2008/0075049 A1
(43) Pub. Date: Mar. 27, 2008

(54) THIN CLIENT WIRELESS COMMUNICATION DEVICE

(75) Inventor: Qiaobing Xie, South Barrington, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/535,516

(22) Filed: Sep. 27, 2006

(51) Int. Cl. H04Q 7/24

(52) U.S. Cl. 370/338

(57) ABSTRACT

A thin client wireless communication device and method and server for providing services to a thin client wireless communication device are disclosed. The method includes receiving, from at least one thin client device, at least one request for a service. A user profile of a current user of the thin client device is determined by an information processing system remotely located from the thin client device. A partition in a memory for at least partially performing the requested service is updated by the information processing system. The method also includes providing the requested service to the thin client device via a wireless communication channel. The requested service is provided to the thin client device based at least in part on the determined user profile associated with the thin client device.

### FIELD OF THE INVENTION

The present invention generally relates to the field of wireless communication devices, and more particularly relates to a thin client wireless communication device.

### BACKGROUND OF THE INVENTION

Recent developments in wireless communication technology have enabled wireless communication devices to become multimedia centers. For example, wireless communication devices can now view and record video, stream audio, perform navigating functions, and the like. As consumer demand grows the capabilities of wireless communication devices will increase. As the capabilities of the devices increase so does the cost of the device. Another problem with current devices is the high bandwidth required by the device because of its capabilities. Many current wireless communication devices can transmit video and audio to other devices thereby using high amounts of bandwidth. Bottlenecks in the network often occur due to over usage of the system resources. These bottlenecks make the network inefficient.

Therefore a need exists to overcome the problems with the prior art as discussed above.

### SUMMARY OF THE INVENTION

Briefly, in accordance with the present invention, disclosed are a thin client wireless communication device (hereinafter “thin client device”) and a method and server for providing services to the thin client device. The method includes receiving a request for a service from a thin client device. A profile of a current user of the thin client device is determined by an information processing system remotely located from the thin client device. A partition in a memory for at least partially performing the requested service is updated by the information processing system. The method also includes providing the requested service to the thin client device via a wireless communication channel. The requested service is provided to the thin client device based at least in part on the determined user profile associated with the thin client device.

In another embodiment of the present invention, a server for supporting wireless communication of the thin client device is disclosed. The server includes an information processing system and memory, communicatively coupled with the information processing system. The memory is for storing a profile of a current user of the thin client device. The memory is further for storing a partition associated with the thin client device. The server also includes a wireless communication interface, communicatively coupled with the information processing system, for communicating with the thin client device. The information processing system with the partition in the memory performs, at least in part, wireless communication control and signaling functions of the thin client device that it uses to communicate in the wireless communication system.

In yet another embodiment, a thin client device is disclosed. The thin client device comprises a processor and a wireless transceiver that is communicatively coupled with the processor for wirelessly communicating in a wireless communication system. The thin client device also includes memory that is communicatively coupled with the processor for storing data associated with wireless communication. A wireless communication interface, is also included that is communicatively coupled with the processor for wirelessly communicating with a communication server that supports wireless communication control and signaling functions of the thin client device. The processor receives control and data signals transmitted from the communication server that are used by the thin client device in performing wireless communication control and signaling functions.

One advantage of the present invention is that low-cost wireless communication devices can be produced that comprise a multitude of multi-media capabilities. An embodiment of the present invention moves all call function and signal handling off of the wireless communication device and onto an applications-services server residing on the wireless network. A thin client device according to an embodiment of the present invention comprises only the necessary components for receiving a user's input requests, wireless connectivity, and displaying output to a user. Software applications and other components not necessary for the wireless communication device to function reside on the applications-services server, which provides these services to the wireless communication device. Therefore, the complexity of the device is low and less expensive devices can be produced.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention, in which:

FIG. 1 is a schematic diagram illustrating a wireless communication system according to an embodiment of the present invention;

FIG. 2 is a schematic diagram illustrating a more detailed view of a thin client device according to an embodiment of the present invention;

FIG. 3 is a block diagram illustrating a more detailed view of the applications-services server according to an embodiment of the present invention; and

FIGS. 4-5 are operational flow diagrams illustrating a process of providing services to a thin client device.

### DETAILED DESCRIPTION

The present invention as would be known to one of ordinary skill in the art can be produced in hardware or software, or in a combination of hardware and software. However, in the present embodiment the invention is implemented in software. The system, or method, according to the inventive principles as disclosed in connection with the preferred embodiment, may be produced in a single computer system having separate elements or by means for performing the individual functions or steps described or claimed or may be arranged in a distributed computer system, interconnected by any suitable means as would be known by one of ordinary skill in the art.

According to the inventive principles as disclosed in connection with the preferred embodiment, one of ordinary skill in the art will recognize that the invention and the inventive principles are not limited to any particular kind of computer system but may be used with any general purpose computer arranged to perform the functions described and the method steps described. The operations of such a computer, as described above, may be according to a computer program contained on a medium for use in the operation or control of the computer. The computer medium, which may be used to hold or contain the computer program product, may be a fixture of the computer such as an embedded memory or may be on a transportable medium such as a disk.

The invention is not limited to any particular computer program logic, language, or instruction but may be practiced with any such suitable program, logic, language, or instructions. Without limiting the principles of the disclosed invention, any such computing system can include, inter alia, at least a computer readable medium allowing a computer to read data, instructions, messages or message packets, and other computer readable information from the computer readable medium. The computer readable medium may include non-volatile memory, such as ROM, Flash memory, floppy disk, Disk drive memory, CD-ROM, and other permanent storage. Additionally, a computer readable medium may include, for example, volatile storage such as RAM, buffers, cache memory, and network circuits.

Furthermore, the computer readable medium may include computer readable information in a transitory state medium such as a network link and/or a network interface, including a wired network or a wireless network that allows a computer to read such computer readable information.

Wireless Communication System

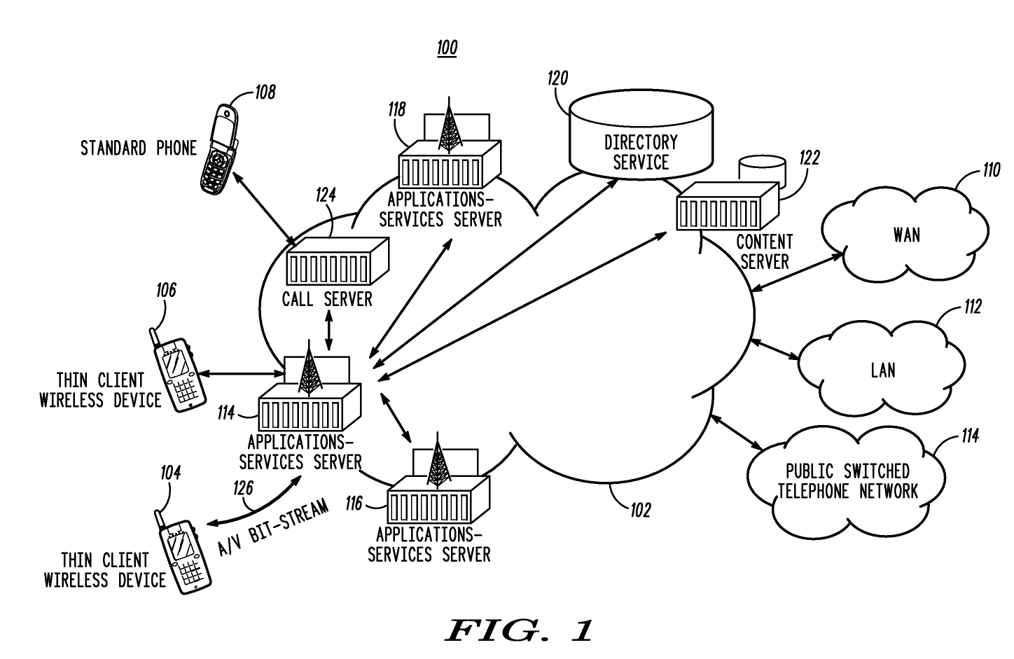

According to an embodiment of the present invention, as shown in FIG. 1, an exemplary wireless communications system 100 is illustrated. FIG. 1 shows a wireless communications network 102 that connects wireless communication devices 104, 106, 108 to each other or a wide area network 110, a local area network 112, and a public switched telephone network 114. The wireless communications network 102, according to the present example, comprises a mobile phone network, a mobile text messaging device network, a pager network, or the like. Further, the communications standard of the wireless communications network 102 of FIG. 1 comprises Code Division Multiple Access (CDMA), Time Division Multiple Access (TDMA), Global System for Mobile Communications (GSM), General Packet Radio Service (GPRS), Frequency Division Multiple Access (FDMA), IEEE 802.16 family of standards, Orthogonal Frequency Division Multiplexing (OFDM), Orthogonal Frequency Division Multiple Access (OFDMA), or the like. Additionally, the wireless communications network 102 comprises text messaging standards, for example, Short Message Service (SMS), Enhanced Messaging Service (EMS), Multimedia Messaging Service (MMS), or the like. The wireless communications network 102 also allows for push-to-talk over cellular communications between capable wireless communication devices.

The wireless network 102 supports any number of wireless communication devices 104, 106, 108. The support of the wireless network 102 includes, but is not limited to, support for mobile telephones, smart phones, text messaging devices, handheld computers, pagers, beepers, or the like. A smart phone is a combination of 1) a pocket PC, handheld PC, palm top PC, or Personal Digital Assistant (PDA), and 2) a mobile telephone. More generally, a smartphone can be a mobile telephone that has additional application processing capabilities. In one embodiment, wireless communications network 102 allows for mesh networking between the wireless communication devices 104, 106.

The wireless communications network 102 supports a thin client device 104, 106. A thin client device, in one embodiment, is a wireless terminal comprising only the components necessary for receiving a user's input request, displaying output to a user, and communicating with an applications-services server 114, 116, 118. For example, layer 3 (“L3”) functions such as network path management, end to end data connection, call control/signaling/messaging, application data exchange, and the like do not have to reside on the wireless communication device. Instead, applications-services server 114, 116, 118 can perform these functions for the thin client device 104, 106. The thin client device is discussed in further detail below.

The applications-services server 114, 116, 118, in one embodiment, communicates with the thin client devices 104, 106, 108, for example, via a bi-directional A/V stream 126 over a wideband L2 connection. In one embodiment, the applications-services server 114, 116, 118 and the thin client device 104, 106 communicate using the 802.16e WiMax standard. However, it should be noted that the present invention is not limited to a WiMax standard, and any ultra wideband connection can be used.

In one embodiment, the applications-services server 114, 116, 118 connects a thin client device 104 to other thin client devices 106, standard wireless communication devices 108 (devices that include call function and signaling control), or networks such as the wide area network 110, the local area network 112, and the public switched telephone network 114. The thin client device 104, 106, in one embodiment, is an I/O extension of all the mobile communication applications, including ordinary wireless applications such as telecommunication applications that are hosted on the applications-services server 114, 116, 118. The thin client device 104, 106 can support any multi-media applications without changing the terminal hardware/software since all the media handling and controlling functions for any new application only need to be added to the applications-services server 114, 116, 118.

In one embodiment, when the thin client device 104, 106 powers on, it connects to an applications-services server 114, 116, 118 that is servicing the area where the thin client device 104, 106 is located. The thin client device 104, 106, in one embodiment, connects to the applications-services server 114, 116, 118 via an ultra wideband L2 connection. Once connected to the applications-services server 114, 116, 118, in one embodiment, the thin client device 104, 106 transmits a universal user ID (“UUI”) to the applications-services server 114, 116, 118. The UUI allows the applications-services server 114, 116, 118 to identify the current user of the thin client device 104, 106. The UUI also allows the applications-services server 114, 116, 118 to retrieve a user profile associated with the user. For example, after a user purchases a new thin client digital watch, the user inputs his/her UUI into the device as part of the initial setup or personalization of the new watch. A user can also own multiple thin client devices at the same time and personalize them with the same UUI. In another embodiment, the thin client device 104, 106 also transmits identification information about its hardware configuration and/or capabilities to the applications-services server 114, 116, 118. For example, the thin client device 104, 106 can transmit its screen size and resolution, camera availability and resolution, keyboard availability, and the like.

This is advantageous because a user may have more than one thin client device such as a cell-phone type wireless communication device, a watch type wireless communication device, or any other multi-media capable wireless communication device. As discussed above, all of these devices can be personalized with the same UUI. A user can also use a thin client device already assigned to another UUI. In this example, the user can enter his/her own UUI into the device for the duration of use. The thin client capability and the wireless connectivity capability can be implemented on a chip that can be added to these devices. Because the thin client device 104, 106 only uses components to receive a user's input requests, display content to a user, and connect with an applications-services server 114, 116, 118, various devices with various capabilities can be a thin client device according to an embodiment of the present invention.

Once the applications-services server 114, 116, 118 receives the UUI from the thin client device 104, 106, the applications-services server 114, 116, 118 queries a centralized UUI directory service 120 to get a user profile associated with the current user of the thin client device 104, 106. In one embodiment, the applications-services server associates the user profile to a device when the user's UUI is presented by the device. In another embodiment, the UUI directory service 120 can be a database distributed across two or more systems. The UUI directory service 120 can include for each user of a thin client device 104, 106 a list of services available to the user. For example, a user's preferred GUI configuration, types and providers of applications owned by/subscribed to by the user, preferred color scheme and wallpaper for display, preferred key layout, and the like, can be stored for a user in the UUI directory service 120. In another embodiment, the configuration information discussed above associated with each user of the thin client devices 104, 106 can also be stored at the UUI directory service 120 or at another remote location.

As discussed above, the thin client device 104, 106, in one embodiment, does not include any L3 or above functions such as application clients or endpoints, nor does the thin client device 104, 106 include call control functions above wireless data connectivity. The thin client device 104, 106 comprises enough layer 2 (“L2”) and below functionality for making and maintaining the wireless data connectivity. Therefore, when a user desires to start a communication session (e.g., an audio and/or video call) the keystrokes performed by the user are detected and interpreted by the applications-services server. The applications-services server 114,116,118 determines what function is requested by the thin client device 104, 106 based on the signal(s) received from the thin client device 104, 106. For example, when a keystroke or the equivalent (e.g., depression of a button, sliding a switch, tapping the screen) occurs at the thin client device 104, 106 a signal is sent to the applications-services server 114, 116, 118.

Based on the hardware/software configuration received from the thin client device 104, 106, the information retrieved from the UUI directory service 120, and the request received from the thin client device 104, 106, the applications-services server 114, 116, 118 renders the display and key mapping on the thin client device 104, 106. The applications-services server 114, 116, 118 begins to manage a bi-directional A/V bit-stream(s) 126 to/from the thin client device 104, 106 as well as process any keystrokes from the thin client device 104, 106. For example, if the applications-services server 114, 116, 118 receives a request from the thin client device 104, 106 for placing a call to another wireless communication device, the applications-services server 114, 116, 118 renders a display to be presented on the thin client device 104, 106 and places the call. In other words, the applications-services server 114, 116, 118 performs all of the call control and signaling and runs any application necessary for the call. In one embodiment, the applications-services server 114, 116, 118 is communicatively coupled to a call server 124 which performs the call control and signaling functions. Similarly, if another device such as another thin client device, standard wireless communication device, or a land-line phone places a call to the thin client device 104, 106, the applications-services server 114, 116, 118 receives the call and renders a display on the thin client device 104, 106 so the user can interact with the incoming call.

During a call, the applications-services server 114, 116, 118 terminates user data from other call participants and forwards the received media content (e.g., audio, video, and the like) to the thin client device 104, 106 via the A/V stream 126. Also, the user's A/V input is received by the applications-services server 114, 116, 118, encoded into the proper format and sent to the other participants.

Other actions such capturing audio/video, playing audio and video, web browsing, email, text messaging, navigation, and the like can be provided to the thin client device 104, 106 via the applications-services server 114, 116, 118. The thin client device 104, 106, in one embodiment, acts as an I/O interface of the communication applications in the applications-services server 114, 116, 118. In one embodiment, a session with an applications-services server 114, 116, 118 remains as long as the underlying wireless connectivity remains. For example, if the thin client device moves out of range of an applications-services server 114, 116, 118, the session may be lost. However, in another embodiment, applications-services servers 114, 116, 118 can be in communication with one another so that as the thin client device 104, 106 reaches the edge of the servicing area of one applications-services server 114, 116, 118, control can be handed off to another applications-services server 114, 116, 118 servicing the area that the thin client device 104, 106 is crossing into.

One advantage of the present invention is that all L3 functions such as network path management, end to end data connection, call control/signaling/messaging, application data exchange, and the like which are mostly in software, including the OS/kernel are moved off of the wireless device and into an applications-services server. This allows for wireless communication devices to be less expensive and provide more capabilities. Another advantage is that the capabilities of the wireless device are expandable by the system without needing direct physical access to the device by system personnel since the software utilized by the device resides on an applications-services server 114, 116, 118.

Thin Client Device

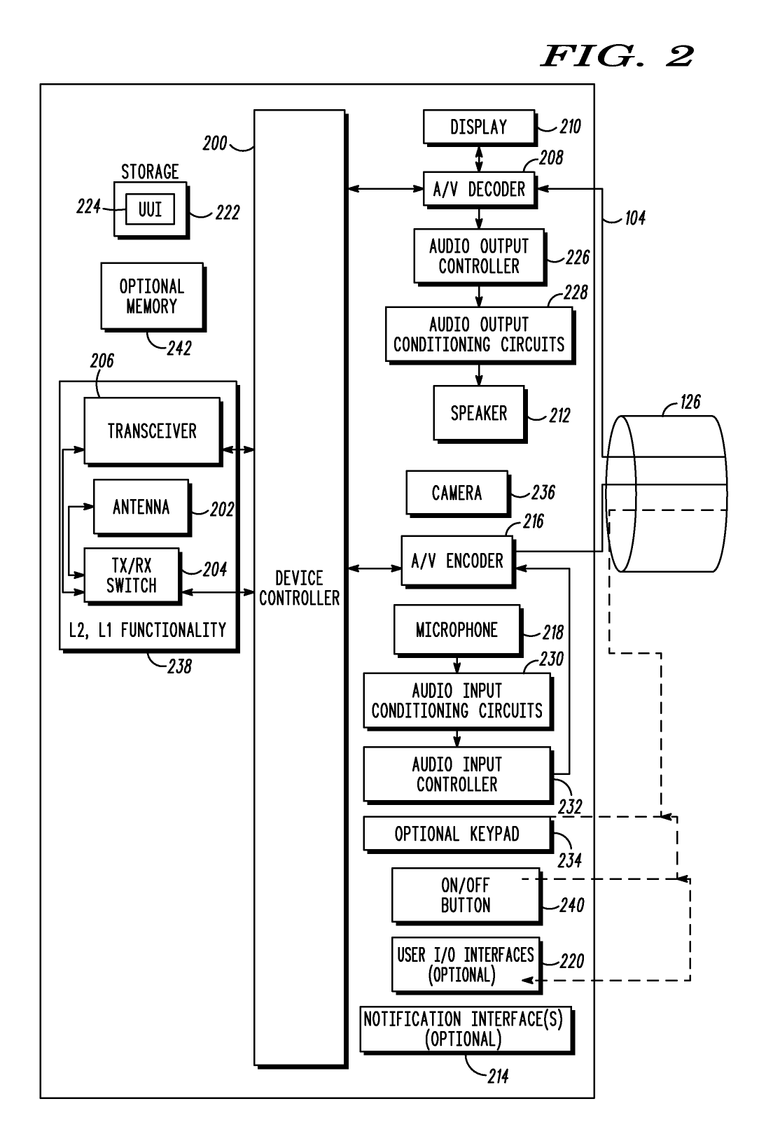

FIG. 2 is a diagram illustrating a more detailed view of the thin client device 104. The thin client device 104 operates under the control of a device controller/processor 200, that controls the sending and receiving of wireless communication signals. In receive mode, the device controller 200 electrically couples an antenna 202 through a transmit/receive switch 204 to a transceiver receiver 206. The transceiver 206 passes the received signal to an A/V decoder 208, which decodes the received signal. Once the signal is decoded, it can be passed to an output device such as a display 210, speaker 212, optional notification interfaces 214, or the like.

In transmit mode, the device controller 200 electrically couples the antenna 202 through the transmit/receive switch 204, to the transceiver 206. An A/V encoder 216 encodes signals received from A/V input devices such as a microphone 218, optional user interfaces 220 and the like, which are then communicated to the transceiver 206 for transmitting.

The thin client device 104, in one embodiment, includes non-volatile storage memory 222 for storing, for example, the UUI 224, which uniquely identifies the current user of the thin client device 104 to the connected applications-services server 114. In another embodiment, optional volatile memory 242 is included for storing A/V information received from the applications-services server 114. The thin client device 104 further includes an audio output controller 226 that receives decoded audio output signals from the A/V decoder 208. The audio controller 226 sends the received decoded audio signals to the audio output conditioning circuits 228 that perform various conditioning functions. For example, the audio output conditioning circuits 228 may reduce noise or amplify the signal. A speaker 212 receives the conditioned audio signals and allows audio output for listening by a user. The audio output controller 226, audio output conditioning circuits 228, and the speaker 212 also allow for an audible alert to be generated notifying the user of a missed call, received messages, or the like. The wireless communication device 104 further includes additional optional user I/O interfaces 220, for example, a head phone jack (not shown), a hands-free speaker (not shown), touch screen technology (not shown), a joystick (not shown), a scroll wheel (not shown), and the like.

The thin client device 104 also includes a microphone 218 for allowing a user to input audio signals into the thin client device 104. Sound waves are received by the microphone 218 and are converted into an electrical audio signal. Audio input conditioning circuits 230 receive the audio signal and perform various conditioning functions on the audio signal, for example, noise reduction and echo cancellation. An audio input controller 232 receives the conditioned audio signal and sends a representation of the audio signal to the A/V encoder 216, which then passes the signal on to the device controller 200.

The thin client device 104 also comprises an optional keyboard 234 for allowing a user to enter information into the thin client device 104. The keyboard 234 is optional because the applications-services server 114 can provide an on-screen keyboard for the thin client device 104 or the applications-services server 114 can use a software based voice-activated user interface in lieu of the keyboard 234. The thin client device 104 further comprises an optional camera 236 for allowing a user to capture still images or video images that are transmitted to the applications-services server 114. The images can be stored on the applications-services server 114 or on a remote information processing system. In one embodiment, an optional peripheral interface (not shown) is also included for allowing the connection of a data cable to the thin client device 104. In one embodiment of the present invention, the connection of a data cable allows the thin client device 104 to be connected to a computer or a printer.

A notification (or indication) interface 214 can also be included on the thin client device 104. In one embodiment, the notification interface 214 includes a visual notification interface for rendering a visual notification (or visual indication) to the user, such as a sequence of colored lights on the display 210 or one ore more flashing LEDs (not shown). For example, a received multimedia message may include a sequence of colored lights to be displayed to the user as part of the message. Alternatively, the visual notification interface can be used as an alert by displaying a sequence of colored lights or a single flashing light on the display 210 when the thin client 104 receives a message, or the user missed a call.

In another embodiment, the notification interface 214 also includes an optional tactile interface for delivering a vibrating media component, tactile alert, or the like. For example, a multimedia message received by the thin client device 104 may include a video media component that provides a vibration during playback of the multimedia message. The tactile interface, in one embodiment, is used during a silent mode of the thin client device 104 to alert the user of an incoming call or message, missed call, or the like. The tactile interface allows this vibration to occur, for example, through a vibrating motor or the like.

The thin client device 104 also includes a display 210 for displaying information received from the applications-services server 114. Also shown in FIG. 2 are Layer 1 (“L1”) and L2 functions 238. L1 functions are usually referred to as physical layer, which corresponds to RF components, such as RF amplification, modulation/demodulation, and the like. L1 essentially provides the physical media for the communications to happen. L1 is normally in the hardware (in silicon). L2 is normally referred to as MAC (media access control) layer that determines who is allowed to access the physical media at any one time. It is primarily concerned with the control of access to the physical transmission medium (i.e. which of the stations attached to the wire or frequency range has the right to transmit) or low-level media-sharing protocols, detecting corruption of loss of data over the over-the-air link and performing retransmission, etc. L2 is normally implemented in hardware and/or firmware, and often inside the same chip set as L1. The A/V decoder 208, A/V encoder 216 and any other input/output interfaces such as the optional keypad 234 and buttons like an on/off button 240 produce signals that can be transmitted to the applications-services server 114 through a bi-directional bit-stream 126 over an L2 connection.

Information Processing System

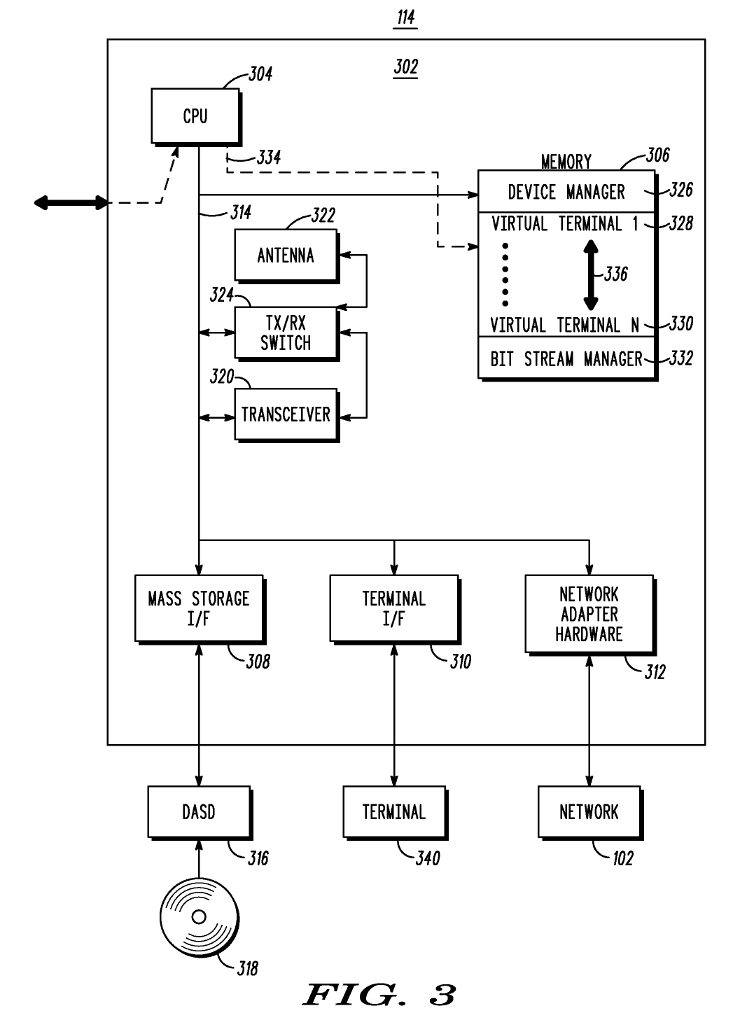

FIG. 3 is a block diagram illustrating a more detailed view of the applications-services server 114. The applications-services server 114 is based upon a suitably configured processing system adapted to implement the exemplary embodiment of the present invention. Any suitably configured processing system such as a personal computer, workstation, or the like, is similarly able to be used as the applications-services server by embodiments of the present invention. The applications-services server 114 includes a computer 302. The computer 302 has a processor 304 that is connected to a main memory 306, mass storage interface 308, terminal interface 310, and network adapter hardware 312. A system bus 314 interconnects these system components. The mass storage interface 308 is used to connect mass storage devices, such as data storage device 316, to the applications-services server. One specific type of data storage device is a computer readable medium such as a CD drive, which may be used to store data to and read data from a CD or DVD 318 or floppy diskette (not shown). Another type of data storage device is a data storage device configured to support, for example, NTFS type file system operations.

The applications-services server 114 also includes a transceiver 320 for sending and receiving wireless communication signals to/from the thin clients and other wireless network 102 elements. In transmit and receive mode, the antenna 322 is electrically coupled through a transmit/receive switch 324 to the transceiver 320. The transceiver 320 passes a received signal to the processor 304 for processing. In another embodiment, the applications-services server 114 can wirelessly communicate with the thin client devices 104, 106 via the network adapter 312. The network adapter 312 also allows the applications-services server 114 to either wirelessly and/or by a wired connection communicate with other network elements such as the call server 124, content server 122, the directory service 120, and the like. Embodiments of the present invention are able to be adapted to work with any data communications connections including present day analog and/or digital techniques or via a future networking mechanism.

In one embodiment, the main memory 306 comprises a device manager 326, a bit-stream manager 332, and a plurality of virtual terminals 328, 330. The device manager 326 manages each of the thin client devices communicatively coupled to the applications-services server. For example, the device manager 326 manages requests for service from a connected thin client device 104, 106 and also manages requests from an outside device (e.g., a standard wireless communication device, a land-line phone, a thin client on another applications-services server, and the like) that want to connect with a connected thin client device 104, 106. A request for service can be a request for multi-media, a call request, a text message request, a network connection request and the like.

The device manager 326, in one embodiment, manages the UUIs received from each of its connected thin client devices 104, 106. The device manager 326 also manages hardware configuration and/or capability information received from thin client devices 104, 106. As discussed above, the thin client device 104, 106 can transmit its screen size and resolution, camera availability and resolution, keyboard availability, and the like. In another embodiment, this information can reside on a remote server such as the directory service server 120 that the applications-services server 114 can access.

Using the UUI provided by a device, the applications-services server 114 can query the directory service 120 to determine a list of services available to the user and user preferences. Using this information in conjunction with the configuration information of the thin client devices 104, 106, the applications-services server 114 provides the requested service to the thin client devices 104, 106 or connects a thin client device 104, 106 to a requesting device. For example, if the configuration of the thin client device states that it does not have a keypad, but has a touch screen, the applications-services server 114 can render a keypad to be displayed on the device's screen. This rendered display is transmitted to the thin client device 104, 106 via the L2 ultra wide band connection 126 so that a display driver can present the on-screen keypad to the user. As discussed above, any available software application for the device type can be provided to the thin client device over the bit-stream connection 126.

A virtual terminal 328, 330 of the main memory 306, in one embodiment, is a partition of memory that is allotted to a connected thin client device 104, 106. This memory space is used for executing whatever application is required to provide the thin client device 104, 106 its requested service or for participating in a service requested by another device (e.g., an incoming call with the thin client device as the destination). As a user performs a function on the thin client device 104, 106 such as hitting a key or tapping the screen, the applications-services server 114 receives signals associated with these functions. Based on the device's configuration and subscribed to services, the device manager 326 can determine the service requested by the thin client device 104, 106.

As the thin client device 104, 106 powers on, it searches for the applications-services server 114, 116, 118. Once it locates an applications-services server 114 and establishes a L2 connection with the applications-services server 114, it transmits the stored UUI of its current user and its configuration information to the applications-services server 114. Upon receiving the UUI, the applications-services server 114 queries the UUI directory server 120 to obtain the user profile including a list of services available to the user and user preferences. Then a bit-stream manager 332 establishes a bi-directional A/V stream (bit-stream) 126 with the thin client device 104, 106. The applications-services server 114 can then transmit an on-screen display (e.g., menus, icons, and the like) so the user can select a service, look at a calendar, and the like. The bi-directional A/V bit-stream 126 allows the thin client device 104, 106 and the applications-services server 114 to communicate.

One advantage of the present invention is that all of the software applications, multimedia, and the like associated with a thin client reside either on the applications-services server and/or a remote server. This allows for thin client devices 104, 106 on the applications-services server 114 to exchange data without tying up the network. For example, a signal only needs to be sent to the applications-services server 114 to exchange data and since the data is already on the server it does not need to be transmitted over the network. This is shown by the dashed line 334 representing the applications-services server receiving a request to exchange data between thin client devices 104, 106 from the A/V bit-stream 126. The arrow 336 represents the exchange of data between the two virtual terminals 328, 330.

Although illustrated as concurrently resident in the main memory 306, it is clear that respective components of the main memory 306 are not required to be completely resident in the main memory 306 at all times or even at the same time. In one embodiment, the applications-services server 114 utilizes conventional virtual addressing mechanisms to allow programs to behave as if they have access to a large, single storage entity, referred to herein as a computer system memory, instead of access to multiple, smaller storage entities such as the main memory 306 and data storage device 316. Note that the term “computer system memory” is used herein to generically refer to the entire virtual memory of the applications-services server 114.

Although only one CPU 304 is illustrated for computer 302, computer systems with multiple CPUs can be used equally effectively. Embodiments of the present invention further incorporate interfaces that each includes separate, fully programmed microprocessors that are used to off-load processing from the CPU 304. Terminal interface 310 is used to directly connect one or more terminals 340 to computer 302 to provide a user interface to the computer 302. These terminals 340, which are able to be non-intelligent or fully programmable workstations, are used to allow system administrators and users to communicate with the thin client device. The terminal 340 is also able to consist of user interface and peripheral devices that are connected to computer 302 and controlled by terminal interface hardware included in the terminal I/F 310 that includes video adapters and interfaces for keyboards, pointing devices, and the like.

An operating system (not shown), according to an embodiment, can be included in the main memory and is a suitable multitasking operating system such as the Linux, UNIX, Windows XP, and Windows Server 2001 operating systems. Embodiments of the present invention are able to use any other suitable operating system, or kernel, or other suitable control software. Some embodiments of the present invention utilize architectures, such as an object oriented framework mechanism, that allows instructions of the components of the operating system (not shown) to be executed on any processor located within the client. The network adapter hardware 312 is used to provide an interface to the network 102. Embodiments of the present invention are able to be adapted to work with any data communications connections including present day analog and/or digital techniques or via a future networking mechanism.

Although the exemplary embodiments of the present invention are described in the context of a fully functional computer system, those skilled in the art will appreciate that embodiments are capable of being distributed as a program product via floppy disk, e.g. floppy disk 318, CD ROM, or other form of recordable media, or via any type of electronic transmission mechanism.

Process For Providing Services To A Thin Client Device

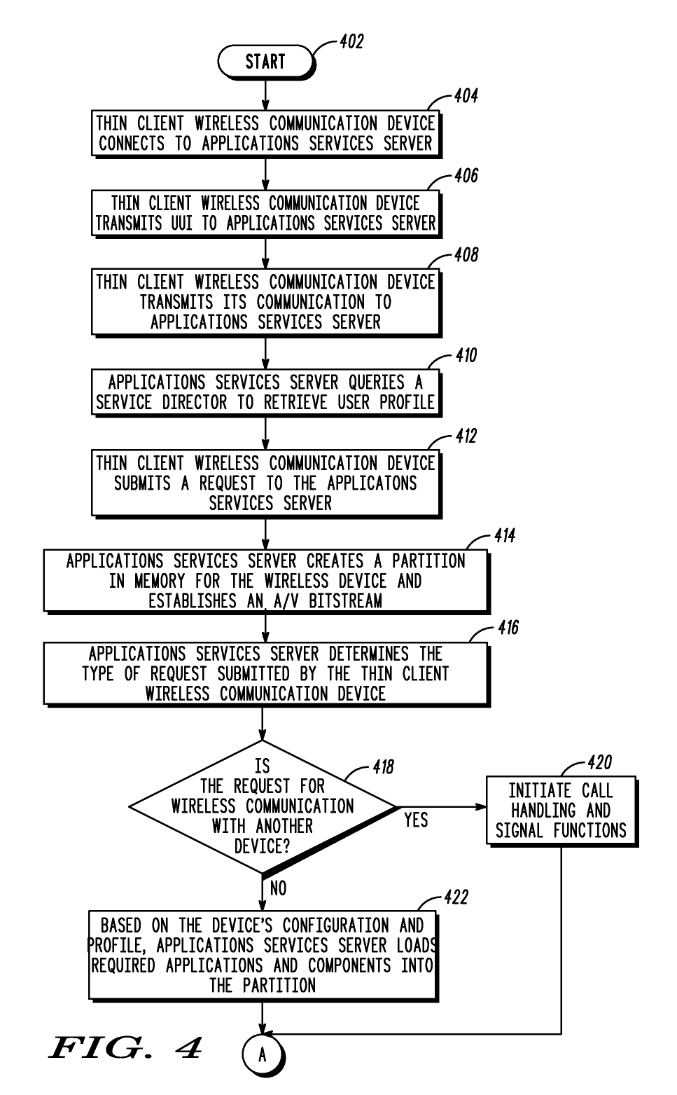

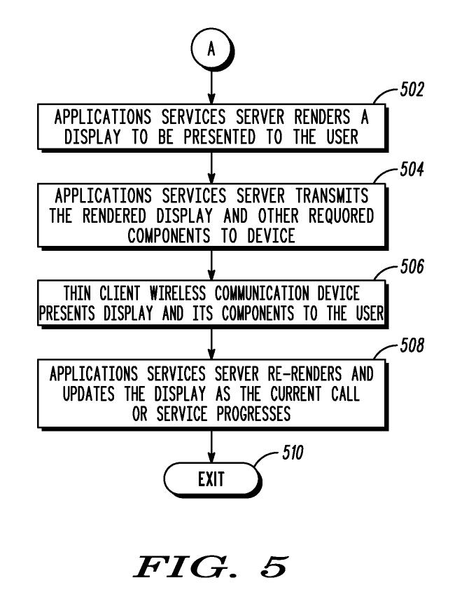

FIGS. 4 and 5 show a process for providing services to a thin client device 104, 106. The operational flow diagram of FIG. 4 begins at step 402 and flows directly to step 404. The thin client device 104, at step 404, locates and connects to an applications-services server 114 via an L2 connection. The thin client device 104, at step 406, transmits its UUI to the applications-services server 114. The thin client device 104, at step 408, also transmits its configuration to the applications-services server 114. The configuration in one embodiment can be screen size and resolution, camera availability and resolution, keyboard availability, and the like. In another embodiment, the configuration of a thin client device 104 can reside at a database on the applications-services server 114 or a remote server.

Once the applications-services server 114 has the UUI, the applications-services server 114, at step 410, queries a service directory 120 to obtain a user profile and associates the returned user profile with the thin client device 104. The profile, in one embodiment, lists the services available to the user and user preferences. For example, a user's preferred GUI configuration, types and providers of applications owned by/subscribed to by the user, preferred color scheme and wallpaper for display, preferred key layout, and the like, can be stored for a user in the UUI directory service server 120. In another embodiment the profile information can also be stored at the UUI directory service server 120 or at another remote location.

The thin client device 104, at step 412, submits a request to the applications-services server 114. For example, a user may have pressed a key to signal the applications-services server 114 that the user wants to call another device, send a text message, take a picture, and the like. The applications-services server 114, at step 414, creates a partition in memory for the thin client device 104 and establishes an A/V bit-stream 126 to the thin client device 104. The A/V bit stream 126, in one embodiment, is a logical bi-directional data pipe overlaid over the L2 connection. The A/V bit-stream 126, in one embodiment, passes the multi-media application data from the applications-services server 114 to the thin client wireless device 104, 106. The applications-services server 114, at step 416, determines the type of request made by the thin client device 104 based on its configuration and profile.

In an alternative embodiment, the creation of a partition at step 414 can occur prior to the thin client device 104, 106 submitting a request to the applications-services server 114 at step 412. In such an example, the applications-services server 114 uses the device configuration information (from step 408) and the user profile (from step 410) to render a virtual terminal 328 in its memory 306 for the thin client device 104, 106, and establishes a logical A/V bit-stream 126 to the thin client device 104, 106.

The applications-services server 114, at step 418, determines if the request is for calling another device. If the result of this determination is positive, the applications-services server 114, at step 420, initiates call functioning and signaling control for the thin client device 104 and begins the call. The control then flows to entry point A of FIG. 5. If the result of the determination is negative, the applications-services server 114, at step 422, loads the required software (which can be obtained from a content server 122) and components for providing the requested service to the thin client device 104 based on the configuration and profile information. The control then flows to entry point A of FIG. 5.

The applications-services server 114, at step 502, renders a display to be presented on the device including the necessary components for the thin client device 104 to perform the requested service. For example, the applications-services server 114 can render a display according to the device's screen resolution, user color preferences, and the like. The display can also include components such as an on-screen keyboard, end-call button, mute button, and the like that allow the user to perform specific functions associated with the service. The applications-services server 114, at step 504, transmits the rendered display and other required components to the thin client device 104 over the A/V bit-stream 126. The thin client device 104, at step 506, presents the display and other required components to the user. As the call or service currently engaged in by the user progresses, the applications-services server 114, at step 508, re-renders and updates the display on the thin client device 104, 106. The control flow then exits at step 510. It should be noted that a similar process is performed when the thin client wireless device 104 is a target device for another device's service such as a call, text message, push-to-talk service, data exchange, and the like.

### NON-LIMITING EXAMPLES

The present invention can be realized in hardware, software, or a combination of hardware and software. A system according to a preferred embodiment of the present invention can be realized in a centralized fashion in one computer system or in a distributed fashion where different elements are spread across several interconnected computer systems. Any kind of computer system—or other apparatus adapted for carrying out the methods described herein—is suited. A typical combination of hardware and software could be a general purpose computer system with a computer program that, when loaded and executed, controls the computer system such that it carries out the methods described herein.

In general, the routines executed to implement the embodiments of the present invention, whether implemented as part of an operating system or a specific application, component, program, module, object or sequence of instructions may be referred to herein as a “program.” The computer program is typically comprised of a multitude of instructions that will be translated by the native computer into a machine-readable format and hence executable instructions. Also, programs are comprised of variables and data structures that either reside locally to the program or are found in memory or on storage devices. In addition, various programs described herein may be identified based upon the application for which they are implemented in a specific embodiment of the invention. However, it should be appreciated that any particular program nomenclature is used merely for convenience, and thus the invention should not be limited to use solely in any specific application identified and/or implied by such nomenclature.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A method for providing services to a thin client device, the method comprising:
receiving a request for a service from a thin client device;
determining, with an information processing system remotely located from the thin client device, a user profile of a current user of the thin client device;
updating, with the information processing system, a partition in a memory for at least partially performing the requested service, wherein the partition is associated with the thin client device; and
providing the requested service to the thin client device via a wireless communication channel, wherein the requested service is provided to the thin client device based at least in part on the determined user profile associated with the thin client device.

2. The method of claim 1, further comprising:
performing, at least in part at the information processing system, wireless communication control and signaling functions of the thin client device that it uses to wirelessly communicate in the wireless communication system.

3. The method of claim 1, where the determining comprises:
receiving, from the thin client device, a unique identifier of the current user of the thin client device;
retrieving, with the information processing system, a user profile associated with the current user of the thin client device based on the unique identifier.

4. The method of claim 1, wherein the user profile comprises at least one of:
identification of a set of software applications associated with the current user of the thin client device; and
a set of user preferences associated with the current user of the thin client device.

5. The method of claim 1, further comprising:
receiving, from thin client device, device configuration information including at least configuration information associated with a set of hardware components communicatively coupled to the thin client device.

6. The method of claim 1, further comprising:
determining, with the information processing system, a type of service request requested by the thin client device.

7. The method of claim 6, wherein determining the type of service request comprises:
analyzing the user profile of the current user of the thin client device and device configuration information associated with the thin client device.

8. The method of claim 6, wherein determining the type of service request further comprises:
receiving, at the information processing system, information associated with at least one action taken by the current user at the thin client device.

9. The method of claim 1, further comprising:
determining that the requested service is for wirelessly communicating with at least one other wireless communication device;
performing, at least in part with the assistance of the information processing system, wireless communication control and signaling functions for the thin client device; and
establishing a wireless communication between the thin client device and the at least one other wireless communication device.

10. The method of claim 1, further comprising:
determining that the requested service is for exchanging data with at least one other wireless communication device;
determining that the at least one other wireless communication device is associated with a partition in the memory; and
exchanging the data between the partition associated with the thin client device and the partition associated with the at least one other wireless communication device.

11. The method of claim 1, wherein the partition stores program and data that instantiates a virtual terminal associated with the thin client device.

12. The method of claim 1, further comprising:
rendering display information associated with the requested service;
transmitting to the rendered display information to the thin client device for presenting via a display to the current user of the device; and
updating the display in accordance with the rendered display information.

13. A server for supporting wireless communication of a thin client device in a wireless communication system, the server comprising:
an information processing system;
memory, communicatively coupled with the information processing system, for storing a user profile of a current user of the thin client device in a wireless communication system, and further for storing a partition associated with the at least one thin client device; and
a wireless communication interface, communicatively coupled with the information processing system, for communicating with the thin client device in the wireless communication system, the information processing system with the partition in the memory performing, at least in part, wireless communication control and signaling functions of the thin client device.

14. The server of claim 13, wherein the user profile comprises at least one of:
identification of a set of software applications associated with the current user of the thin client device; and
a set of user preferences associated with the current user of the thin client device.

15. The server of claim 13, wherein a second partition in the memory is associated with at least one other wireless communication device, and wherein the information processing system, in response to determining that a service request received from the thin client device requests exchanging data with the at least one other wireless communication device, exchanges data between the partition associated with the thin client device and the partition associated with the at least one other wireless communication device.

16. A thin client device, comprising:
a processor;
a wireless transceiver, communicatively coupled with the processor;
memory, communicatively coupled with the processor, for storing data associated with device communications; and
a wireless communication interface, communicatively coupled with the processor, for wirelessly communicating with a communication server that supports wireless communication control and signaling functions of the thin client device, the processor receiving control and data signals transmitted from the communication server and that are used by the thin client device in performing wireless communication control and signaling functions of the thin client device.

17. The thin client device of claim 16, wherein the processor and wireless communication interface operate to transmit a service request to the communication server requesting to exchange data between the thin client device and another wireless communication device, wherein the requested exchange of data does not require communication of the data between the thin client device and the other wireless communication device.

18. The thin client device of claim 17, wherein the service request requests the exchange of the data between a first memory partition associated with the thin client device and a second memory partition associated with the other wireless communication device.

19. The thin client device of claim 18, wherein the first memory partition and the second memory partition are located in memory that is communicatively coupled with the communication server.
